(19) United States
(12) Patent Application Publication
(10) Pub. No.: US 2014/0214470 A1
(43) Pub. Date: Jul. 31, 2014

(54) SYSTEM, METHOD AND APPARATUS FOR MANAGING THE PROCESS OF FILING FOR BENEFITS CLAIMS

(71) Applicant: THE AMERICAN LEGION, Indianapolis, IN (US)

(72) Inventors: Daniel S. WHEELER, Indianapolis, IN (US); Ronald Jeffrey STOFFER, Indianapolis, IN (US)

(73) Assignee: THE AMERICAN LEGION, Indianapolis, IN (US)

(21) Appl. No.: 13/753,123

(22) Filed: Jan. 29, 2013

(51) Int. Cl. G06Q 10/10

(52) U.S. Cl. CPC G06Q 10/1057
USPC 705/7.19; 705/322

(57) ABSTRACT

The present invention relates to a system, method and computer-readable storage medium for managing the process of claims benefits. The system comprises an electronic device configured to display on a screen of the electronic device a plurality of steps to be completed by a claimant, the steps being related to the process of filing the claim for benefits. The electronic device is also configured to receive input via an interface of the electronic device indicating that a selected one of steps has been completed by the claimant and to display on the screen a visual indication that the selected step has been completed. The electronic device is also configured to provide information to help the claimant complete at least one of the steps.

### FIELD OF THE INVENTION

The present invention relates to apparatuses, methods, and systems for facilitating the filing of benefits claims and, in particular, a mobile application that guides a claimant through the process of filing a benefits claim with Veteran Affairs (“VA”).

### BACKGROUND OF THE INVENTION

Currently, the process of filing for a benefits claim with a private or government agency, such as the Department of Veteran Affairs (“DOVA”), may prove lengthy, tedious and often confusing for individuals seeking such benefits. Not being familiar with applicable rules and procedures, these individuals often find it difficult to prepare for and anticipate exactly what is required at each step of the claims process. While customer service or help lines may be available, it is often difficult to reach an assistant and, even when reached, the assistant may not prove helpful. Also, individuals may need one on one attention and a more personalized guide in the process of filing for a benefits claim. It would be beneficial for an individual to be able to find out information and answers about the process of filing a benefits claim conveniently and efficiently. There is, thus, a need for a tool to help guide an individual through the process of filing a benefits claim.

### SUMMARY OF THE INVENTION

According to the principles of the invention, a method and system are provided for managing the process of filing a claim for benefits and, in particular, the process of filing a benefits claim with the Department of Veteran Affairs. In accordance with instructions of a suitable software application resident on an electronic device (such as a mobile smart phone or tablet), steps associated with the claims process are organized and displayed on a screen of the electronic device so that the claimant can keep track of his/her progress through the claims process. Information is also provided to the claimant to assist him/her to complete the steps. As steps are completed, the claimant can mark steps as complete via the electronic device, such as with a checkmark or other suitable designation. In this manner, the process of filing for claims benefits can be effectively and easily managed.

In some embodiments, questions are displayed to the claimant on the screen requesting information related to the claimant. From the answers provided by the claimant, the system determines whether the claimant can benefit from filing the claim for benefits. The system then displays an appropriate message on the screen of the electronic device based on the determination. This way, the claimant can be assured that the inventive system and method described herein would be of use before expending considerable time and effort in the process.

In other embodiments, the system and method receive from the interface of the electronic device a selection of at least one additional step related to the process of filing the claim for benefits, and add the additional step to the list of steps displayed on the screen of the electronic device. In another embodiment, the system and method also display on the screen of the electronic device a plurality of categories, with a subset of the steps being associated with each category. In this way, the claimant can customize the list of steps in accordance with particular requirements of his/her claim, which may be displayed in a organized and streamlined fashion.

### BRIEF DESCRIPTION OF THE DRAWINGS

The present invention may be understood more fully by reference to the following detailed description of the preferred embodiment of the present invention, illustrative examples of specific embodiments of the invention and the appended figures in which:

FIG. 1 is an example of a home page of a mobile application in accordance with some embodiments of the present invention;

FIGS. 2A and 2B are examples of pages of the mobile application that display questions regarding the utility of the application, in accordance with some embodiments of the present invention;

FIG. 3 is an example of a Claims Coach page of the mobile application in accordance with some embodiments of the present invention;

FIGS. 4A and 4B are examples of pages of the mobile application that display the tasks of the first step of the process in accordance with some embodiments of the present invention;

FIG. 5 is an example of a page of the mobile application that enables a search for a service officer in accordance with some embodiments of the present invention;

FIG. 6 is an example of a page of the mobile application that displays service officer search results in accordance with some embodiments of the present invention;

FIG. 7 is an example of a page of the mobile application that displays a appointment date window in accordance with some embodiments of the present invention;

FIG. 8 is an example of a page of the mobile application that displays help information in accordance with some embodiments of the present invention;

FIGS. 9A and 9B are examples of pages of the mobile application that display tasks of the second step of the process in accordance with some embodiments of the present invention;

FIG. 10 is an example of a page of the mobile application that displays tasks of the third step of the process in accordance with some embodiments of the present invention;

FIG. 11 is an example of a page of the mobile application that displays tasks of the fourth step of the process in accordance with some embodiments of the present invention;

FIGS. 12A and 12B are examples of pages of the mobile application that display resources for each step of the process in accordance with some embodiments of the present invention;

FIG. 13 is an example of a page of the mobile application that displays an overall checklist of tasks in the process in accordance with some embodiments of the present invention; and

FIG. 14 is an example of a logical diagram of the structure of the mobile application in accordance with some embodiments of the present invention.

### DETAIL DESCRIPTION OF THE PREFERRED EMBODIMENTS

The present system, method and apparatus will be described in connection with the figures, it being understood that the description and figures are for illustrative, non-limiting purposes.

The present invention relates to a software application for guiding individuals through the process of filing benefits claims with the VA. In one embodiment, the application comprises a mobile application (or “App”) downloadable from the Internet or other source, such as a App store, onto a hand-held device, such as, for example, a mobile phone, a smart phone, PDA, tablet, etc. It should be appreciated, however, that other embodiments of the inventive application are not limited to mobile devices and may comprise applications configured for execution on non-mobile devices, such as, for example, a desktop computer. Other embodiments are contemplated.

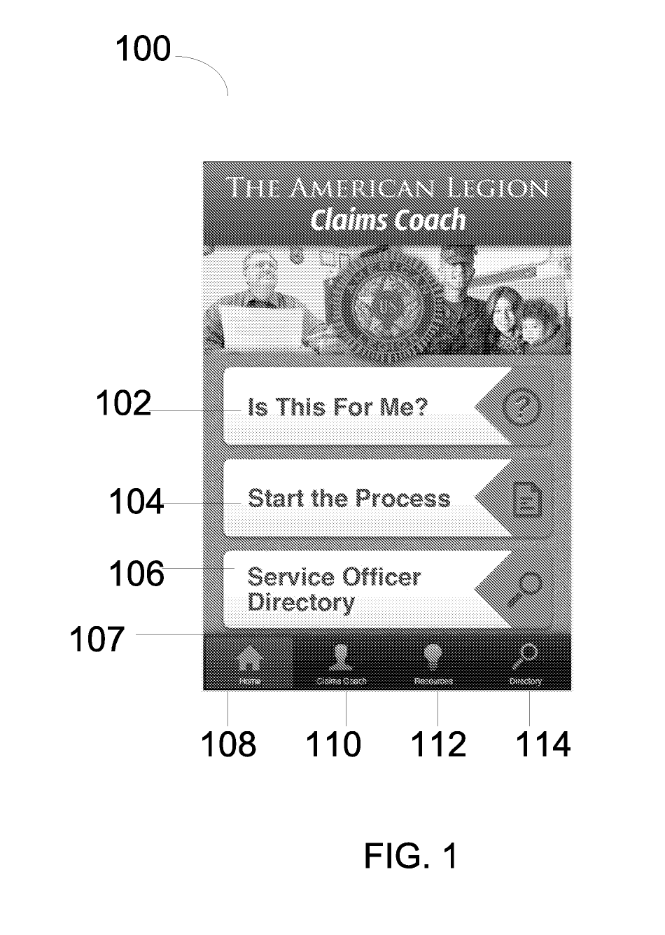

Referring now to FIG. 1, there is seen a home page 100 of a first exemplary mobile application according to the present invention. After a claimant downloads the mobile application to the hand-held device, the claimant begins the process by opening the mobile application on the hand-held device. Home page 100 includes menu options “Is This For Me?” 102, “Start the Process” 104, and “Service Officer Directory” 106, as well as a navigational menu 107 including navigational options Home 108, Claims Coach 110, Resources 112, and Directory 114 (shown on all pages). It should be appreciated that interface 100 may include different and/or additional menu options providing different functionality and/or may appear visually different.

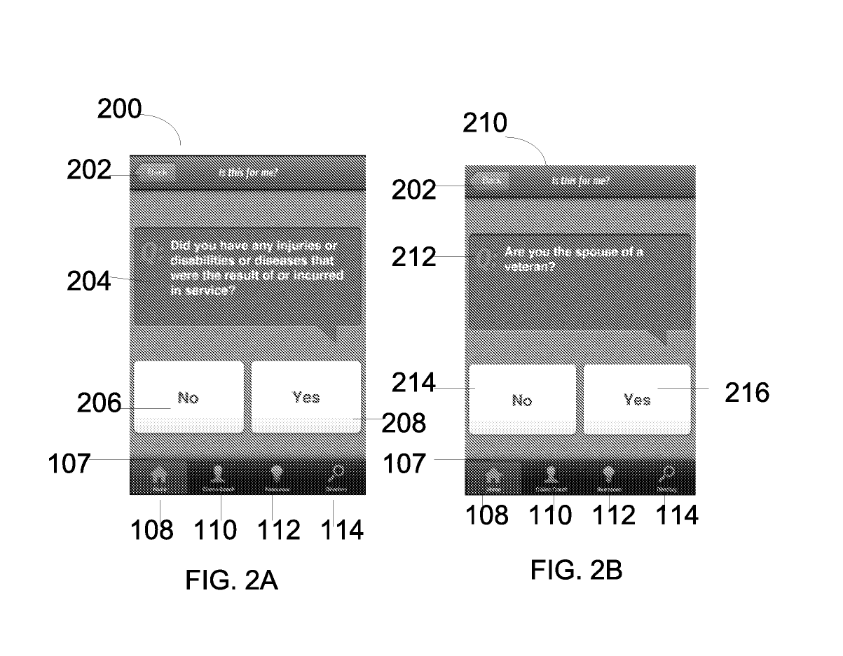

When clicked, menu option “Is This For Me?” 102 displays a series of pages with answerable questions designed to assist a claimant in determining whether the mobile application would be of benefit to him/her, such as exemplary pages 200 and 210 of FIGS. 2A and 2B, respectively. Each of pages 200, 210 includes a question 204, 212, to which the claimant can answer “Yes” (208 and 216) or “No” (206 and 214). A selection of either “Yes” (208 and 216) or “No” (206 and 214) causes the mobile application to progress through additional question pages (not shown), whereas back button 202 reverts the application to previous questions. Different questions are presented to the claimant in sequence until a determination can be made as to whether the application would benefit the claimant. Once such a determination is made, the claimant is informed of such by the mobile application and questioning ceases. For example, if the claimant answers “No” 206 to question 204 of page 200 asking whether the claimant “[has] any injuries or disabilities or diseases that were the result of or incurred in service?,” the mobile application will cease presenting questions and inform the claimant that the application, which is designed to help claimants apply for benefits in connection with service-related injuries/disabilities, would not be useful to him/her. If the claimant answers “Yes” 208 to question 204, additional pages with additional questions (such as question 212 of page 210) are presented in sequence until the application can determine whether it would benefit the claimant. If the application determines it would be of benefit, the application informs the claimant accordingly and invites him/her to click on the “Start the Process” option 104 and proceed with filing a claim.

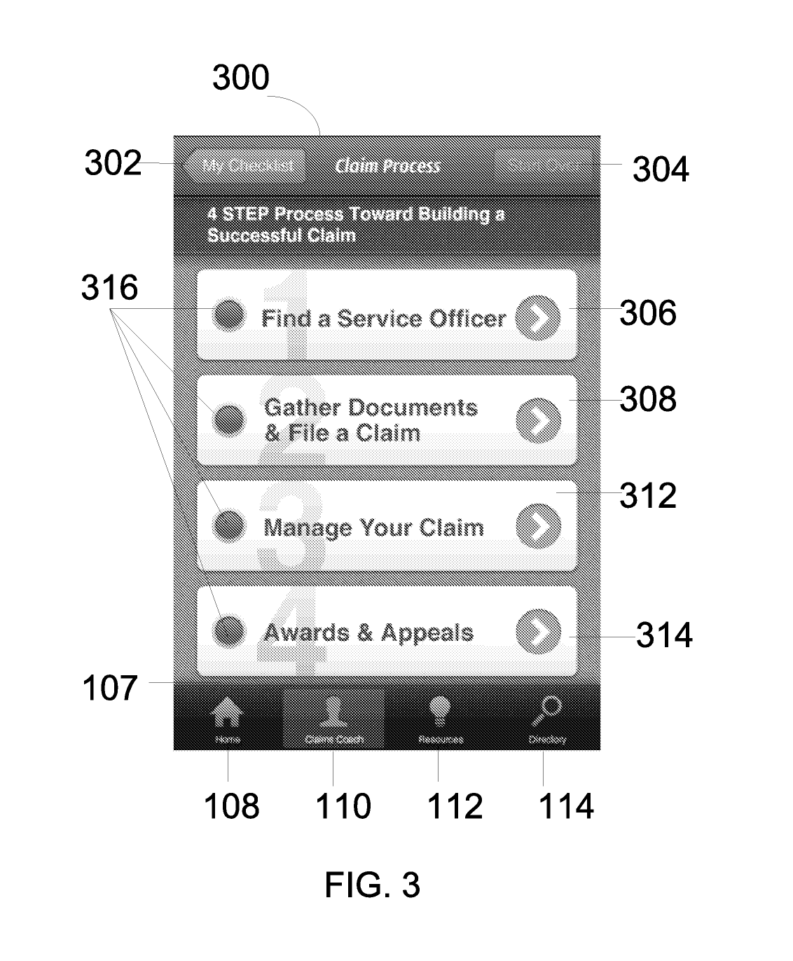

Referring now to FIG. 3, there is seen a page 300 that is displayed to the claimant upon clicking “Start the Process” option 104. Page 300 provides an organizational tool to help guide the claimant through various steps of the VA claim process. In this embodiment, page 300 displays four steps to the claimant: “Find a Service Officer” 306; “Gather Documents & File a Claim” 308, “Manage Your Claim” 312, and “Award & Appeals” 314. Page 300 also displays menu options “My Checklist” 302 and “Start Over” 304, which are described in more detail below. It should be appreciated that the claims process is not limited to the steps and menu options displayed in FIG. 3, and that other embodiments of the present invention may include additional, less or different steps and menu options with different functionality. Page 300 also displays completion indicators 316, corresponding to each step above, that indicate to the claimant whether the claimant is finished with that step, almost finished with that step, or has not started that step. For example, the completion indicators 316 may illustrate different colors depending on how far within that step the claimant has progressed. The completion indicators 316 may appear in different colors, such as red indicating that the claimant has not completed any tasks, yellow indicating that the claimant has completed some tasks but not all, and green indicating that the claimant has completed all tasks associated with that step.

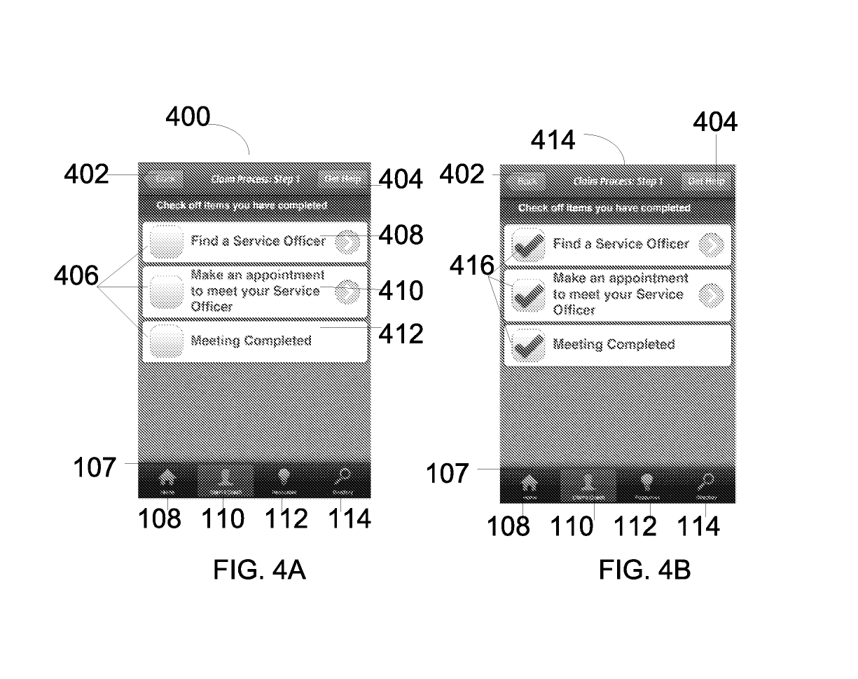

Referring now to FIG. 4A, there is seen a page 400 that is displayed to the claimant upon clicking “Find a Service Officer” option 306. Page 400 includes four clickable tasks for assisting a claimant to locate a VA service officer: “Find a Service Officer” 408; “Make An Appointment To Meet Your Service Officer” 410; and “Meeting Complete” 412, as well as associated check boxes 406. Page 400 also includes a back button 402 for reverting to the previous page, such as page 300 of FIG. 3, and a “Get Help” button 404 for displaying additional information to further assist the claimant in locating a service officer.

Check boxes 406 provide the claimant the ability to mark tasks 408, 410 and 412 as completed. In this manner, a visual aid is provided for helping the claimant and/or the service officer to keep track of completed tasks. It should be appreciated that check boxes 406 may be marked in many different ways, such as with an “X,” a checkmark, or some other indication. In other embodiments, checkboxes 406 are omitted, with tasks being displayed as visually crossed out to indicate completion. FIG. 4B illustrates an exemplary page 414 showing check boxes 406 marked with checkmarks 416. It should be appreciated that pages 400 and 414 are merely exemplary and may be configured in any one of alternative configurations, with less, different or additional tasks, and still conform to the spirit and scope of the invention.

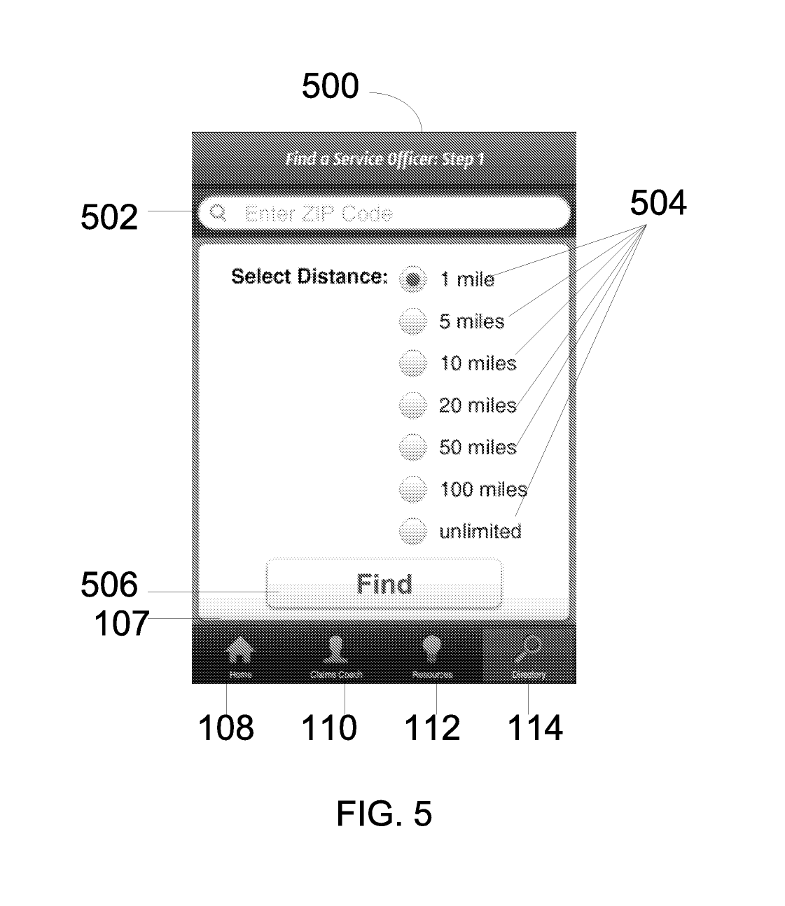

Referring to FIG. 5, there is seen a page 500 displayed to the claimant upon clicking “Find a Service Officer” task 408. In this embodiment, page 500 provides the claimant with the ability to search for and locate a service officer by zip code. For this purpose, page 500 includes a zip code text field 502, range options 504, and a Find button 506. To locate a service officer, the claimant enters a zip code in zip code text field 502 (preferably the zip code of the claimant's residence) and selects the appropriate range option 504 to limit the search to a specified geographical range from the zip code. In this embodiment, range options 504 are provided in increments of 1, 5, 10, 20, 50, 100 and unlimited miles, although other increments and range units (e.g., kilometers) may be used. Next, the claimant clicks Find button 506 to search for service officer(s). To enable the search, the mobile application may be in communication with a server/database storing information relating to the service officers, such as via an Internet connection or other suitable connection. It should be appreciated that the mobile application may provide other methods to search for a service officers, such as, for example, prompting the claimant to search by name, address, city, state, etc.

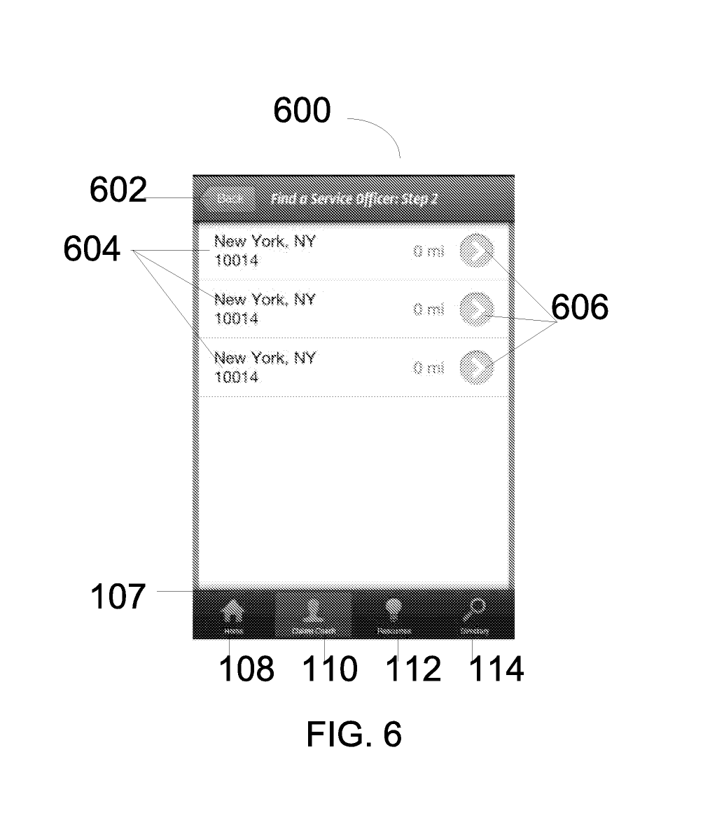

Upon completion of the search, a list of service officers 604 within the range are displayed to the claimant via page 600, as shown in FIG. 6. Each entry in list 604 displays the location of a service officer and an estimated distance of the officer from the claimant-specified zip code. Each entry also includes an arrow 606 that, when clicked, provides contact information for the service officer, such as name, address, telephone, e-mail, etc. (not shown). A back button 602 is also provided to enable the claimant to revert to page 500, change the search parameters and re-run the search. After the search is completed with the appropriate parameters, the claimant may save the contact information for a selected service officer, for example, by clicking an “add to my list” button (not shown).

Once a service officer is selected, the mobile application reverts to page 400 (FIG. 4A). At this point, it would be advisable for the claimant to manually select checkbox 406 associated with “Find a Service Officer” option 408 to indicate completion of the task. It should be appreciated, however, that selection of checkbox 406 may occur automatically upon the claimant saving the contact information for a particular service provider.

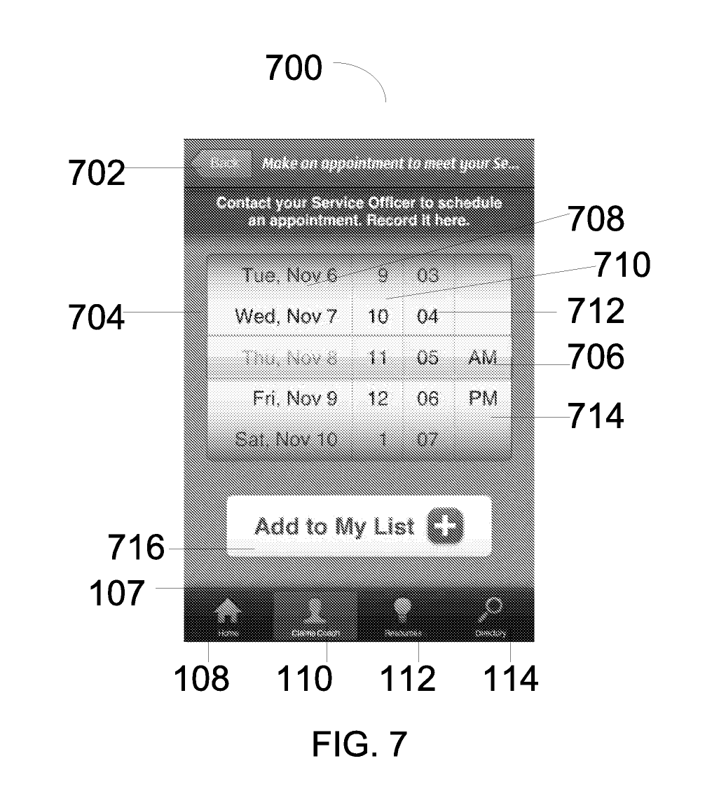

Next, the claimant schedules an initial appointment with the service officer offline, and makes note of the appointment with “Make An Appointment To Meet Your Service Officer” option 412 (see FIG. 4). Referring now to FIG. 7, there is seen a page 700 displayed to the claimant upon clicking “Make An Appointment To Meet Your Service Officer” option 412. Page 700 includes an appointment date window 704, with a date selection column 708, a day column 708, an hour column 710, a minute column 712, and an AM or PM column 714. In this embodiment, each column is individually movable to select the date and time of the appointment. It should be appreciated, however, that the mobile application may permit the claimant to set the appointment date in other ways, such as by a visual calendar. The claimant may also be presented with an option to manually type the date and time into a text field, etc. The meeting between the claimant and the service officer may take place in multiple different forms. For example, the meeting could be in person, over the phone, and/or over video chat. The meeting may provide the claimant with a chance to ask questions specific to the claimant's situation and for the service officer to get to know the specific situation of the claimant.

Once an appointment has been set within the mobile application, the claimant may save the appointment by clicking the “Add to My List” button 716, which reverts the application to page 400 (FIG. 4A). At this point the claimant should select checkbox 406 associated with “Make An Appointment To Meet Your Service Officer” option 412 to indicate that an appointment has been scheduled. As with “Find A Service Officer” option 408, checkbox 406 may also be selected automatically after “Add to My List” button 716 is selected by the claimant. The mobile application may provide appropriate appointment reminders to the claimant, such as via pop-up windows, text messages, emails, etc. The saved date may also be displayed on one or more of the pages of the mobile application, such as page 400. Back button 702 is also provided for enabling the claimant to revert back to the previous page.

In some embodiments, the service officer has access to the same or similar application designed to communicate with the mobile application of the claimant. In this manner, embodiments of the present invention permit certain information to be transmitted between the claimant and service officer automatically. For example, once the claimant selects a service officer using his/her mobile application, the claimant and the service officer's applications may synchronize automatically such that the service officer is notified of the claimant's selection. The synchronization may be facilitated over a wireless (or wired) connection to the Internet. The device synchronization between the claimant and the service officer allows either the to select an appointment and to “push” the appointment to other. Therefore, if either the claimant or the service officer makes a change to the appointment, the other person is notified and the mobile application updates the appointment automatically. In other embodiments, the service officer has the ability to review how far along the claimant is progressing in the claims process, such as reviewing completed tasks, etc.

Once the claimant attends and completes the initial meeting with the service officer, the claimant may select checkbox 406 associated with “Meeting Completed” option 412 on page 400 to indicate completion of the meeting and, accordingly, completion of “Find a Service Officer” step 306 on page 300. In some embodiments, the hand-held device provides location services that can be utilized with the mobile application. For example, a service provider of the hand-held device may provide location information to auto-complete the information needed for the search for the service officer. Also, the hand-held device might include GPS functionality and, therefore, the hand-held device may provide that information to the mobile application. In the event the claimant requires additional information or has difficulty completing “Find a Service Officer” step 306, “Get Help” button 404 on page 400 is operable to provide the claimant with additional information to assist him/her.

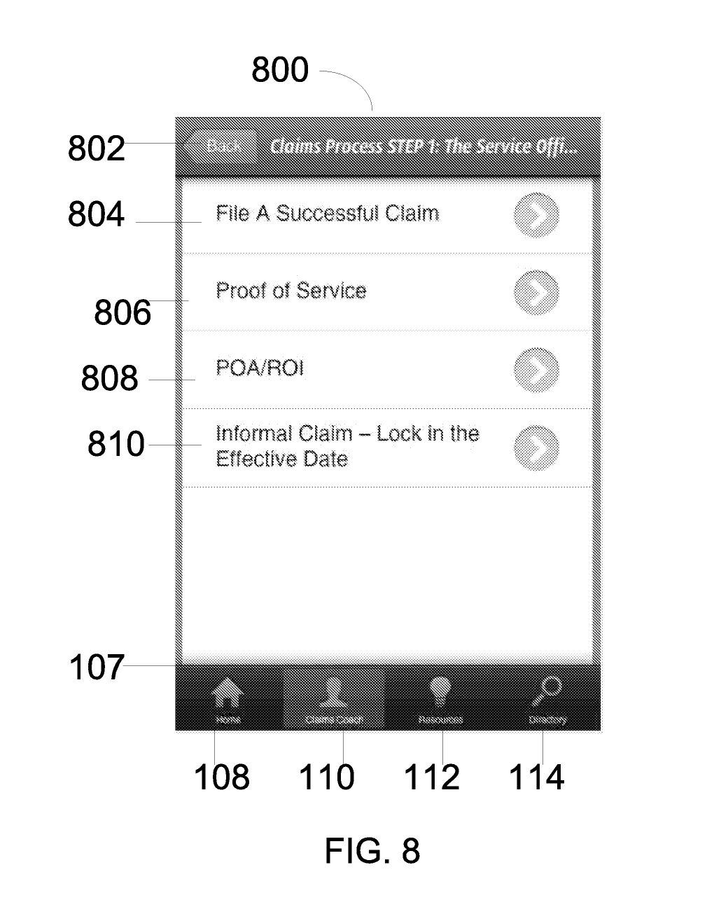

Referring now to FIG. 8, there is seen a page 800 displayed to the claimant upon clicking “Get Help” button 404. Page 800 includes a series of help topics 804, 806, 808 and 810 associated with the process of selecting a service officer, as well as a back button 802 for reverting the application to the previous page. When a topic is selected, information is displayed pertaining to that topic. The information may be displayed in the same interface or in another interface or page.

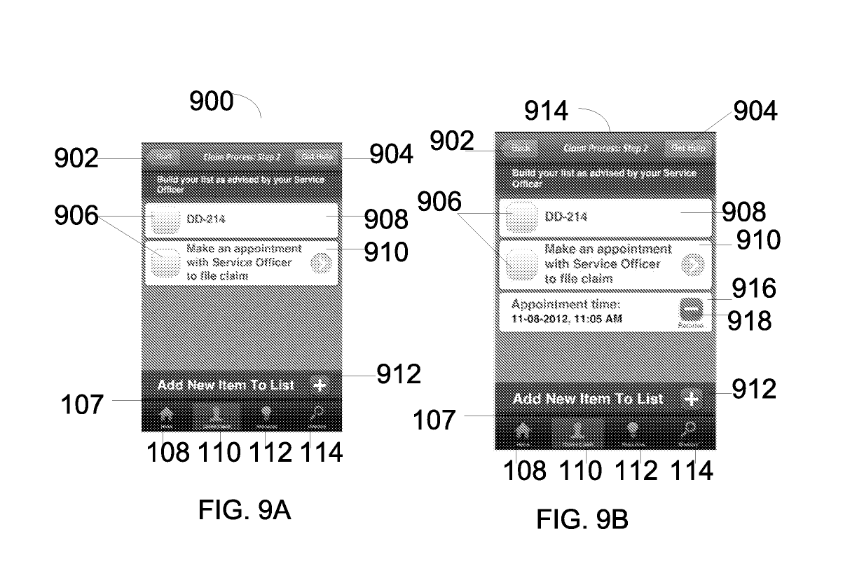

During the initial meeting the claimant and service officer discuss the injury/disability, and the claimant is informed of what forms, documents and other materials he/she must gather in order to file for a benefits claim in connection with the injury/disability. To organize and ease this process for the claimant, page 300 (See FIG. 3) includes “Gather Documents & File a Claim” step 308. Upon clicking this step 308, page 900 (see FIG. 9A) is displayed to the claimant. Interface 900 includes a list of items and steps that must be completed before filing a claim. In the embodiment illustrated in FIG. 9A, a DD-214 item 908 and step 910 for making a subsequent appointment with the service provider are displayed. “DD-214” refers to a “Certificate of Release or Discharge from Active Duty,” which is a pre-requisite to filing any claim for VA benefits. Depending upon the nature of the claim and injury/disability, additional forms or documents may also be required to file a claim. Additional items may be added to the list by clicking the “Add New Item To List” button 912, upon which the claimant is presented with a list of additional items and steps (not shown) to choose from. Examples of additional items include, but are not limited to, account information for direct deposit, divorce decrees, birth certificates, buddy statements, death certificates, doctor's statements, lay statements, marriage certificate(s), private medical records, service medical records, and/or social security numbers. Upon completion of a particular item or step in the list, the claimant may select the appropriate checkbox 906 to signify completion.

Once all of the required documents and forms have been gathered, the claimant makes a second appointment with the service officer to file the claim. After the second appointment is scheduled, the claimant selects step 910 to record the time and date of the second appointment similarly to how the time and date for the initial appointment was recorded using page 700 (see FIG. 7). As described above, the appointment may be automatically updated or configured wirelessly through a connection over the Internet. The appointment time 916 is then saved and displayed to the claimant on page 914, as shown in FIG. 9B. If the appointment time changes or is cancelled, the claimant can delete the recorded appointment time by selecting Remove button 918. In the event the claimant needs assistance at this stage, “Get Help” button 904 may be clicked to receive information on various topics related to “Gather Documents & File a Claim” step 308 of page 300. A back button 902 is also provided to permit the application to revert to the previous page.

Once the claimant gathers all required documents, attends the second meeting and files the claim, “Gather Documents & File a Claim” step 308 will be displayed as completed on page 300 (FIG. 3). In this embodiment, the completion indicator for step 308 will appear as completed (e.g., green). At this stage, DOVA will process the claim, which may require substantial time. DOVA will also likely require the claimant to respond to specific requests and inquiries at different times during the process. To keep track of this, the mobile application provides a “Manage Your Claim” step 312 (See FIG. 3).

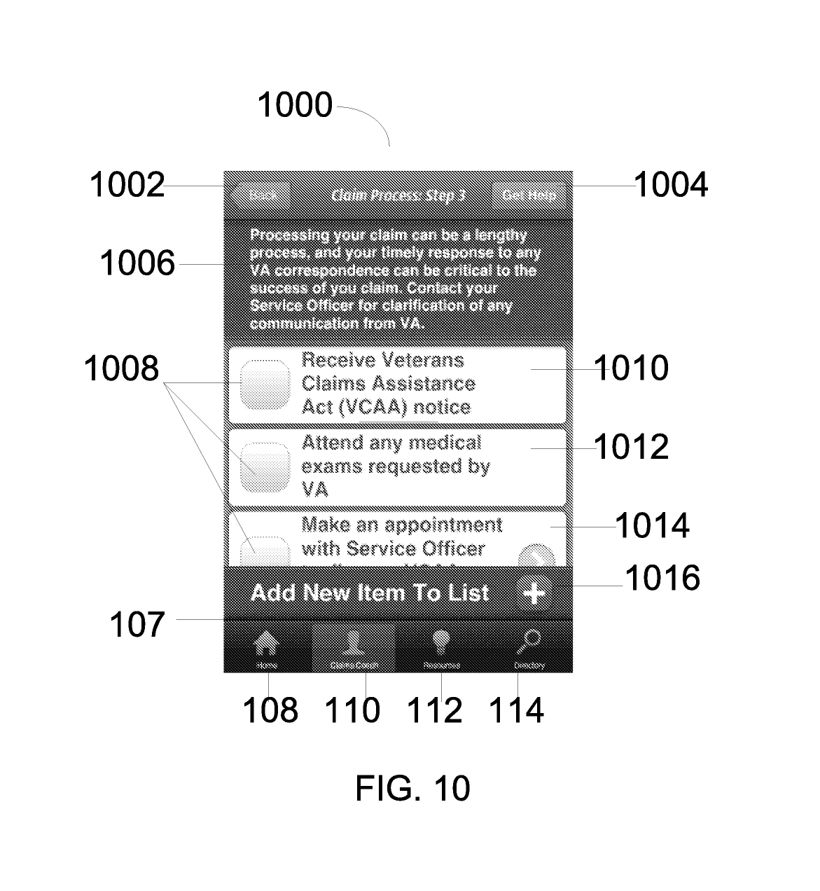

Referring now to FIG. 10, there is seen a page 1000 displayed to the claimant upon clicking “Manage Your Claim” option 312. Page 1000 includes information message 1006 and a list of items and steps 1010, 1012, and 1014 required by DOVA to process the claim. Depending upon the nature of the claim and injury/disability, additional items or steps may be required to complete processing. Additional items 1010, 1012, 1014 may be added to the list by clicking the “Add New Item To List” button 1016, upon which the claimant is presented with a list and or prompted for input of additional items and steps (not shown). Upon completion of a particular item or step 1010, 1012, 1014 in the list, the claimant may select the appropriate checkbox 1008 to signify completion, or the checkbox may be selected automatically. In some embodiments, the mobile application provides the functionality for the claimant or the service officer to wirelessly submit documents or information automatically to DOVA. In turn, DOVA may transmit information to the mobile application (or email address) of the claimant and/or service officer identifying what steps have been completed and what additional information is required, with such appropriate settings being automatically updated within the mobile application.

FIG. 10 illustrates three items or steps that must be complete before processing of the claim is finalized: receipt of the Veterans Claims Assistance Act (VCAA) notice 1010, attendance of any medical exams requested by DOVA 1012, and scheduling an appointment with the service officer to discuss VCAA notice 1014. It should be appreciated, however, that the list of items and steps in FIG. 10 is not exhaustive and may include any other number of tasks, items or steps to be completed. Receipt of the VCAA notice indicates that the claim has been filed and that the claimant has thirty days to either submit additional information or indicate that there is no additional information available. The claimant needs to ensure that any necessary medical exams have been completed. In some embodiments, the mobile application provides information to the claimant that indicates whether or not any or what type of medical exams are necessary for the filing of the claim.

In the event the claimant needs assistance at this stage, “Get Help” button 1004 may be clicked to receive information on various topics related to “Manage Your Claim” step 312 of page 300. A back button 1002 is also provided to permit the application to revert to the previous page.

Once all of the information requested by DOVA is gathered and submitted and all checkboxes 1008 are selected, “Manage Your Claim” step 312 will be displayed as completed on page 300 (FIG. 3). In this embodiment, the completion indicator for step 312 will appear as completed (e.g., green). At this point, the claimant waits until the claim is processed and a decision (also known as a rating decision) is rendered. The decision details all of the requested benefits and whether those benefits are approved or denied. In the event that the claimant receives none or less than the requested benefit, the claimant is given the opportunity to appeal the decision. The inventive mobile application provides an “Awards & Appeals” step 314 (see FIG. 3) to manage this process.

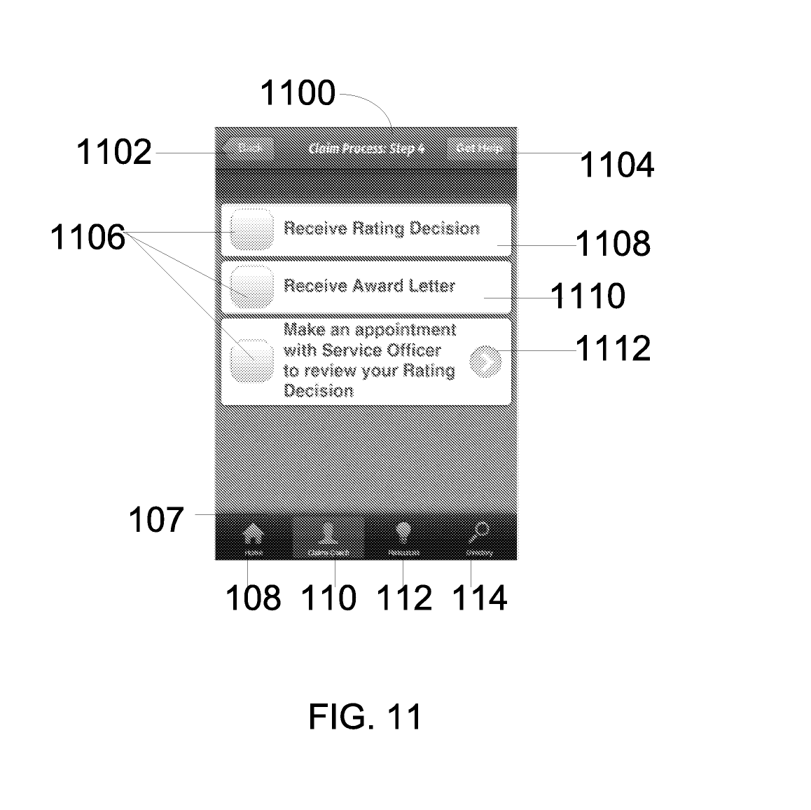

Referring now to FIG. 11, there is seen page 1100 displayed to the claimant upon selection of “Awards & Appeals” step 314. Page 1100 displays a list of items and steps 1108, 1110 and 1112 to be complete after receiving the rating decision. For example, the list of tasks may include, but are not limited to, receipt of rating decision 1108, receipt of award letter 1110, and/or scheduling an appointment with the service officer to review rating decision 1112. It should be appreciated that this list of tasks is not exhaustive and may include any other number of tasks to be completed.

Upon completion of a particular item or step 1108, 1110, 1112 in the list, the claimant may select the appropriate checkbox 1106 to signify completion. In some embodiments, the mobile application provides automatic communication of tasks and progress to the service officer. In the event the claimant needs assistance at this stage, “Get Help” button 1104 may be clicked to display information on various topics related to “Awards & Appeals” step 314 of page 300. A back button 1102 is also provided to permit the application to revert to the previous page.

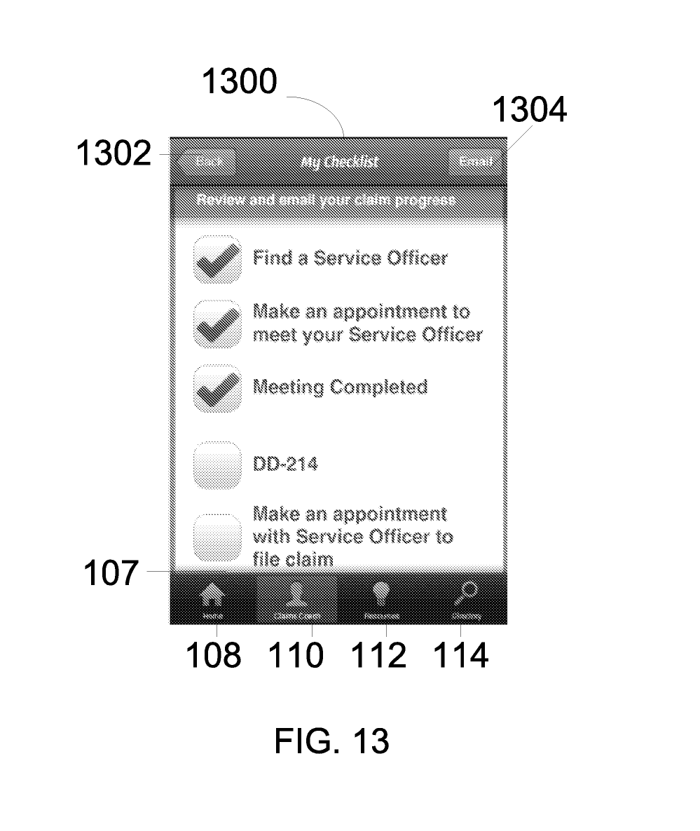

Referring again to FIG. 3, “Start Over” button 304 permits the claimant to erase all saved information and start the claims process anew. In some embodiments, when the “Start Over” 402 option is selected, the mobile application prompts the claimant with a warning page requesting confirmation of the action. This may help prevent the claimant from inadvertently losing some or all of the saved information for the claim process. Otherwise, “My Checklist” button 302 may be selected in order to view a collapsed list of all open and closed items associated with “Find a Service Officer” step, “Gather Documents & File a Claim” step, “Manage Your Claim” step, and “Award & Appeals.” FIG. 13 illustrates an exemplary page 1300 containing such a list. Page 1300 also includes an Email button 1304 that, when clicked, launches a resident e-mail application and inserts the list into a new e-mail message. This permits the claimant to e-mail the list to himself/herself and/or to the service provider. Additional functionality (not illustrated) may permit the claimant to print a hardcopy of the list. In some embodiments, the service officer will receive automatic updates to the claimant's checklist as tasks are completed.

It will be appreciated that navigational menu 107 including navigational options Home 108, Claims Coach 110, Resources 112, and Directory 114, is displayed on all pages illustrated in the Figures. Home option 108 returns the claimant to page 100 or another page determined to be a central point of the mobile application; Claims Coach option 110 returns the claimant to page 300 of FIG. 3; and Directory Option 114 returns the claimant to page 500 of FIG. 5 for locating a service provider. Resources Option 112 displays a list of resources and other information that may prove useful in the claims process.

Navigational menu 107 may also visually indicate which part of the mobile application the claimant is currently accessing. For example, if the claimant is currently viewing the Claims Coach section of the mobile application, Claim Coach 110 button may appear visually different than other navigational menu options. It should be appreciated that the mobile application may highlighted the selected navigational option in a different way, such as by contrasting the lightness or darkness of the selected option, changing the color of the option, etc. It should also be appreciated that navigational menu 107 is not limited to the options illustrated in the Figures, and that other embodiments may include fewer, additional or different options than those depicted.

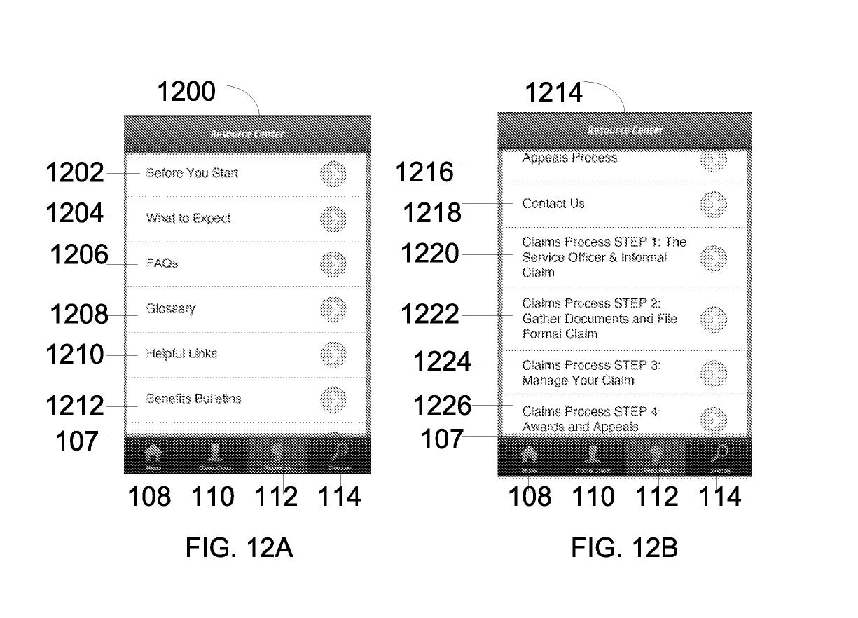

Referring now to FIGS. 12A and 12B, there is seen pages 1200 and 1214 displayed to the claimant upon selection of Resources option 112. Pages 1200 and 1214 include a list of resources topics 1202, 1204, 1206, 1208, 1210, 1212, 1216, 1218, 1220, 1222, 1224, 1226 selectable by the claimant. The list may include any number of resource topics and is not limited to the topics mentioned or described herein. For example, the resource topics may include before you start 1202, what to expect 1204, frequently asked questions (FAQs) 1206, glossary 1208, helpful links 1210, benefits bulletins 1212, appeals process 1216, contact us 1218, “Claims Process STEP 1: The Service Officer & Informal Claim” 1220, “Claims Process STEP 2: Gather Documents and File Formal Claim” 1222, “Claims Process STEP 3: Manage Your Claim” 1224, and/or “Claims Process STEP 4: Awards and Appeals” 1226.

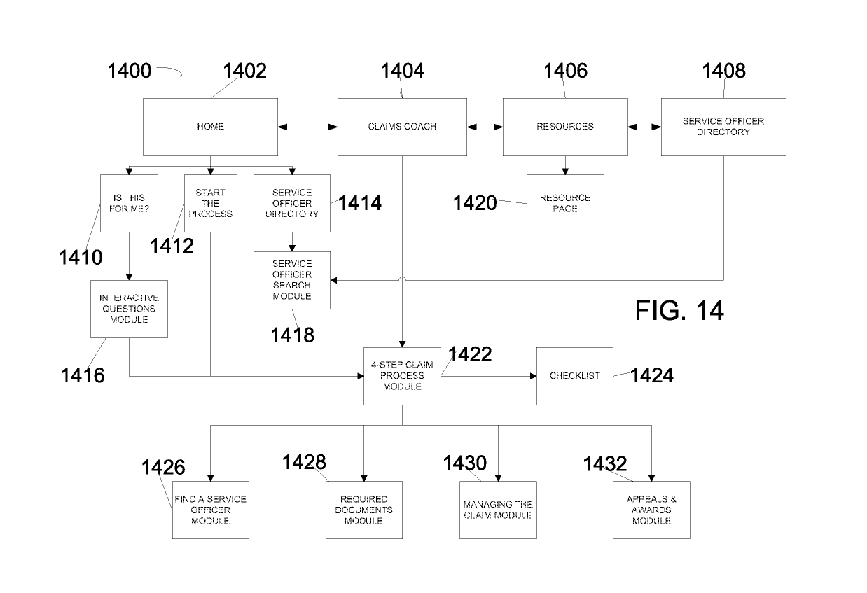

Referring now to FIG. 14, there is seen a logical diagram 1400 of the structure of a mobile application, according to the present invention. While the present embodiment is discussed with respect to a mobile application, it should be appreciated that the structure illustrated in 1400 may also be implemented as a software tool on any computing platform. As shown in FIG. 14, the mobile application includes four menu options: Home 1402, Claims Coach 1404, Resources 1406, and Service Office Directory 1408. It should be appreciated that the menu may include more or less than the options listed here. Also, these four menu options may be accessible from multiple screens within the mobile application. From the Home 1402 menu option, a user may select from three further options: “Is this for me?” 1410, “Start the Process” 1412, and/or “Service Office Directory” 1414. The “Is this for me?” 1410 menu option is similar to the “Is this for me” option 102 in FIG. 1 and, when selected, brings the user to Interactive Questions Module 1416, which, as described above with respect to FIGS. 2A and 2B, displays a list of answerable questions designed to assist a claimant in determining whether the mobile application would be of benefit to him/her. The Start the Process 1412 menu option brings the user to 4-Step Claim Process Module 1422, as described above with respect to the “Start the Process” option of FIG. 1. This Module 1422, which may also be accessed via Claims Coach menu option 1404, provides an organizational tool to help guide the claimant through various steps of the VA claim process, as described above with respect to page 300 of FIG. 3. The Service Office Directory 1414 menu option is similar to option 106 of FIG. 1 and, when selected, brings the user to the Service Office Search Module 1418, which, in accordance with the functionality described above with respect to the FIG. 5, provides the claimant with the ability to search for and locate a service officer by zip code. Service Office Search Module 1418 may also be accessed from “Service Officer Directory” menu option 1408.

If it is determined that the claims process is appropriate for the user, the user is taken to 4-Step Claim Process Module 1422. From the 4-Step Claim Process Module 1422, the user is presented with five menu options which, when selected, bring the user to one of five different modules: checklist module 1424, Find a Service Officer Module 1426, Required Documents Module 1428, Managing the Claim Module 1430, and/or Appeals and Awards Module 1432. The checklist module 1424 displays a collapsed list of all open and closed items associated with the claims process (such as the exemplary list on page 1300 illustrated in FIG. 13), similar to “My Checklist” option 302 described above with respect to FIG. 3. The Find a Service Office Module 1426 functions similarly to “Find a Service Officer” options 306 and 408, described above with respect to FIGS. 3, 4A and 5. The Required Documents Module 1428 displays a list of items and steps that must be completed before filing a claim, similar to the exemplary list described above with respect to “Gather Documents & File a Claim” option 308 of FIG. 3 The Managing the Claim Module 1430 displays a list of selectable items for the user to manage his/her claim and, for this purpose, functions similarly to page 1000 described above with respect to FIG. 10. The Appeals and Awards Module 1432 displays a list of items and steps to be completed after receiving the rating decision, as described above with respect to FIG. 11. The user may also access a “Resources” menu option 1406 to view a list of resources topics on “Resource Page” 1420, as described above with respect to FIGS. 12A and 12B.

The mobile application, hand-held or mobile devices, or other discrete software or hardware components can communicate and are arranged to carry out the illustrative processes and applications described herein by way of sending a signal such as a packet, digital message, or a command within a communication to or between components (and act in response to the receipt of a signal to carry our processes) and between or through supporting software or hardware such as communicating with an operating system, communicating with another resident application through an API or the like, communicating between network elements using an Internet protocol or one or more layers of the OSI model, or communicating through an intermediate component.

The mobile application may operate in coordination with application software running external to the hand-held or mobile device to carry out or provide the intended customization. For example, the mobile application may allow a claimant to set up an account, thereafter interacting with other software to authenticate the claimant or check the status of the claimant's account. Other software features that are subsidiary or are tangential to filing a claims process may be incorporated into the mobile application or provided in conjunction or coordination with other software if desired. The mobile application may also include functionality that would allow communication with a corresponding application that functions on a desktop, laptop, or other type of computing device.

A computing device can include a computer, computer system or other programmable electronic device, including a client computer, a server computer, a portable computer (including a laptop and a tablet), a handheld computer, a mobile phone (including a smart phone), and any combination and/or equivalent thereof (including touchless devices). Moreover, the computing device may be implemented using one or more networked computers, e.g., in a cluster or other distributed computing system. It is understood that the exemplary environment discussed and illustrated is not intended to limit the present disclosure to such devices, and that other alternative hardware and/or software environments may be used without departing from the scope of this disclosure. The present techniques can be applied to devices other than hand-held devices, such as laptops or desktop computers. The hand-held device may include components such as a screen, a keyboard, multiple buttons, an antenna, a speaker, a microphone, a camera, etc. The screen of the hand-held device may be a touch screen or a non-touch screen. The keyboard of the hand-held device may be a physical keyboard with physical buttons or may also be a software keyboard as part of the interface of the hand-held device. The multiple buttons of the hand-held device may be used for any number of functions, such as power, volume, camera, home, etc. It should be appreciated that the hand-held device includes a display screen of some kind and an interface that provides facilitation between the hardware and software components.

The computing device may include local storage for storing the mobile application and other related information and variables. The local storage may include volatile memory (such as RAM) and/or non-volatile memory (such as ROM as well as any supplemental levels of memory, including but not limited to cache memories, programmable or flash memories and read-only memories). The device may also include one or more processing devices (e.g., one or more central processing units (CPUs), one or more graphics processing units (GPUs), one or more microprocessors (μP) and similar and complementary devices) and optional media devices (e.g., a hard disk module, an optical disk module, etc.). Additionally, any storage techniques used in connection with the presently disclosed method and/or system may invariably be a combination of hardware and software.

One or more features illustratively described herein can be implemented individually or in various combinations. The present system, method, or related inventions also relate to a non-transient computer readable medium configured to carry out any one of the methods disclosed herein. The application can be set of instructions readable by a processor and stored on the non-transient computer readable medium. Such medium may be permanent or semi-permanent memory, such as hard drive, floppy drive, optical disk, flash memory, ROM, EPROM, EEPROM, etc., as would be known to those of ordinary skill in the art.

Features or characteristics described in one context, process, or device are applicable to other context, process or devices described herein. The steps of the processes illustratively described herein can be performed in a different order, if desired. Also, steps could be added or removed from the processes illustratively described herein. The processes illustratively described herein can be implemented using the described examples of hardware and network configurations.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the claims to the invention.

What is claimed is:

1. A method of managing a process of filing a claim for benefits, the method comprising:
displaying on a screen of an electronic device a plurality of categories including a first category related to finding a service officer, a second category related to required documents, a third category related to managing the claim for benefits, and a fourth category related to benefit awards and appeals, each category being associated with a subset of steps to be completed in the process of filing the claim for benefits with the Department of Veteran Affairs;
displaying on the screen the subset of steps when the associated category is selected;
providing information via the screen of the electronic device to help the claimant complete at least one of the steps;
receiving input via an interface of the electronic device indicating that a selected one of steps has been completed by the claimant; and
displaying on the screen of the electronic device a visual indication that the selected step has been completed in accordance with the input received from the interface of the electronic device.

2. The method of claim 1, further comprising:
displaying questions on the screen requesting information related to the claimant;
receiving answers to the questions via the interface of the electronic device;
determining whether the claimant can benefit from filing the claim for benefits in accordance with the answers to the questions; and
displaying a message on the screen of the electronic device based on the determination of whether the claimant can benefit from filing the claim for benefits.

3. The method of claim 1, further comprising:
receiving from the interface a selection of at least one additional step related to the process of filing the claim for benefits; and
adding the additional step to the subset of steps displayed on the screen of the electronic device.

4. The method of claim 1, wherein the subset of steps associated with the first category includes a first step related to locating the service officer and a second step related to scheduling an appointment with the service officer.

5. The method of claim 1, wherein the subset of steps associated with the second category includes a first step related to a DD-214 form and a second step related to scheduling an appointment with the service officer.

6. The method of claim 1, wherein the subset of steps associated with the third category includes a first step related to a Veterans claims Assistance Act notice, a second step related to a medical exam, and a third step related to scheduling an appointment with the service officer.

7. The method of claim 1, wherein the subset of steps associated with the fourth category includes a first step related to a rating decision, a second step related to an award letter, and a third step related to scheduling an appointment with the service officer.

8. The method of claim 1, wherein the electronic device is a mobile device.

9. A non-transitory computer-readable media comprising a plurality of instructions that, when executed, cause an electronic device to:
display on a screen of an electronic device a plurality of categories including a first category related to finding a service officer, a second category related to required documents, a third category related to managing the claim for benefits, and a fourth category related to benefit awards and appeals, each category being associated with a subset of steps to be completed in the process of filing the claim for benefits with the Department of Veteran Affairs;
display on the screen the subset of steps when the associated category is selected;
provide information via the screen of the electronic device to help the claimant complete at least one step of the subset of steps;
receive input via an interface of the electronic device indicating that a selected step of the subset of steps has been completed by the claimant; and
display on the screen of the electronic device a visual indication that the selected step has been completed in accordance with the input received from the interface of the electronic device.

10. The computer-readable media of claim 9, wherein the plurality of instructions cause the electronic device to:
display questions on the screen requesting information related to the claimant;
receive answers to the questions via the interface of the electronic device;
determine whether the claimant can benefit from filing the claim for benefits in accordance with the answers to the questions; and
display a message on the screen of the electronic device based on the determination of whether the claimant can benefit from filing the claim for benefits.

11. The computer-readable media of claim 9, wherein the plurality of instructions cause the electronic device to:
receive from the interface a selection of at least one additional step related to the process of filing the claim for benefits; and
add the additional step to the list of steps displayed on the screen of the electronic device.

12. The computer-readable media of claim 9, wherein the subset of steps associated with the first category includes a first step related to locating the service officer and a second step related to scheduling an appointment with the service officer.

13. The computer-readable media of claim 9, wherein the subset of steps associated with the second category includes a first step related to a DD-214 form and a second step related to scheduling an appointment with the service officer.

14. The computer-readable media of claim 9, wherein the subset of steps associated with the third category includes a first step related to a Veterans claims Assistance Act notice, a second step related to a medical exam, and a third step related to scheduling an appointment with the service officer.

15. The computer-readable media of claim 9, wherein the subset of steps associated with the fourth category includes a first step related to a rating decision, a second step related to an award letter, and a third step related to scheduling an appointment with the service officer.

16. The computer-readable media of claim 9, wherein the electronic device is a mobile device.

17. An apparatus for managing the process of filing a claim for benefits, the apparatus comprising:
a screen for displaying information to a claimant;
an input module for receiving information from the claimant;
a home process module configured to display a home page on the screen;
a service officer search module communicatively coupled to and accessible from the home process module, the service officer search module being configured to receive search information via the input module and to display on the screen a list of service officers in accordance with the search information;
an interactive questions module communicatively coupled to and accessible from the home process module, the interactive questions module being configured to display a list of answerable questions on the screen to assist the claimant to determine whether the process of filing the claim for benefits would be of benefit to the claimant; and
a claim process module communicatively coupled to and accessible from the home process module, the service officer search module and the interactive questions module, the claim process module being configured to display on the screen a list of tasks to be completed, and configured to display on the screen information about a claim award or an appeal process associated with the claim for benefits

18. The apparatus of claim 17, further comprising:
a checklist module communicatively coupled to the claim process module, the checklist module configured to display on the screen the list of tasks to be completed;
a required documents module communicatively coupled to the claim process module and to the checklist module, the required documents module configured to display on the screen a first subset of the tasks to be completed, the first subset of tasks relating to documents that are required to be obtained by the claimant;
a claim management module communicatively coupled to the claim process module, to the checklist module and to the required documents module, the claim management module configured to display on the screen a second subset of the tasks to be completed, the second subset of the tasks relating to managing the process of filing the claim for benefits; and
an awards/appeals module communicatively coupled to the claim process module, to the checklist module, to the required documents module, and to the claim management module, the awards/appeals module configured to display on the screen information about the claim award or the appeal process associated with the claim for benefits.
